(19) United States
(12) Patent Application Publication
(10) Pub. No.: US 2022/0055129 A1
(43) Pub. Date: Feb. 24, 2022

(54) SAW BLADE SHARPNESS MECHANISM

(71) Applicant: Deere & Company, Moline, IL (US)

(72) Inventors: Joshua C. Heitsman, Princeton, IA (US); Bryon P. Neumann, Brantford (CA)

(21) Appl. No.: 16/947,830

(22) Filed: Aug. 19, 2020

(51) Int. Cl. B23D 59/00

(52) U.S. Cl. CPC B23D 59/001; B23D 59/008

(57) ABSTRACT

In accordance with an example embodiment, a saw blade sharpness mechanism for use on a tree sawing device, having a saw blade which rotates to saw trees. The saw blade dulls over time during normal operating conditions, and the speed of the saw blade decreases as the saw blade contacts the tree during sawing operation. The speed of the saw blade during sawing operations decreases more after repeated operations as the saw blade dulls. A sensor senses the speed of the saw blade. A processor receives inputs from the sensor and determines when the speed of the saw blade during tree sawing operation has decreased due to wear to a point that it would be more economical to replace the saw blade with a new sharper blade. When such condition is determined, the processor sends a signal to an indicator which sends a signal to the operator.

### TECHNICAL FIELD

The present disclosure generally relates to forestry work vehicles. An embodiment of the present disclosure relates to a mechanism that detects wear of a saw blade used to cut trees.

### BACKGROUND

In tree harvesting operations it is known to provide large vehicles with tree harvesting heads having saw blades that rotate at relatively high RPM's. The rotating saw blades are drawn into contact with the tree near the base of the tree to cut down the tree. The heads often include structure for grabbing the tree as it is cut. The saw blade includes teeth that contact the tree itself, and also sometimes the soil near the base of the tree. Over extended periods of use cutting trees, the saw blade teeth will wear down and become dulled due to contact with the wood of the trees and the adjacent soil. When the saw blade teeth become dull they will not cut through the tree as quickly. A dulled saw blade will significantly slow down when in contact with a tree during sawing operations, whereas a blade with sharp new teeth will cut through the tree efficiently and not be significantly slowed. Dulled saw blade teeth may require the operator to use more fuel to keep the saw blade spinning fast enough to cut the tree. The slowing of the dulled saw blade causes the operator to expend time and fuel speeding up the saw blade to the normal operating speed between tree cuts. Eventually the saw blade teeth will become so worn and dull that it will be more economical for the operator to replace the worn teeth with new ones, or a new blade with all new teeth. Conventional tree harvesting heads require the operator to occasionally check the wear of the saw blade, and he is often uncertain when the blade has become so worn that it should be replaced. Accordingly, there is a need to provide an improved mechanism for determining wear of a saw blade and saw teeth. There is also a need to help the operator determine when to replace worn saw blades and saw teeth.

### SUMMARY

Various aspects of examples of the present disclosure are set out in the claims.

According to an aspect of the present invention, a mechanism is provided for use on a tree sawing head device. The tree sawing head may have a saw blade that rotates to saw trees. The saw blade includes teeth that dull over time during normal operating conditions as the saw blade cuts trees. As the blade teeth dull, the blade will rotate more slowly as it contacts the tree during sawing operations than if it were newer and sharper. A sensor may be provided that is operatively coupled to the saw blade for sensing the speed of the saw blade. A processor may be provided which is operatively coupled to the sensor to receive input from the sensor. The processor may be operatively connected to an indicator that is capable of sending a signal to the operator. The processor may receive input about the cost of the blade, and from the sensor, the speed of the saw blade. The processor may utilize the cost of the blade and the speed input to determine when the blade has dulled to the point that it would be more cost effective to continue sawing operations with a new blade or new teeth, at which point the processor causes the indicator to send a signal to the operator. The processor may receive information about the type of saw blade and/or teeth being used, the type and cost of fuel being used, the type of tree being cut, the type of soil in which the tree is growing, or other vehicle parameters and operating conditions. This other information may be used in determining when it would be more economical to replace the blade and/or its teeth.

According to another aspect of the present disclosure, a camera can be provided to sense the speed of the saw blade. According to yet another aspect of the present disclosure, the saw blade includes an index. The index can be a marking on the tooth of the saw blade, or a shape formed on the tooth of the saw blade. The camera can be directed at the saw blade to see when the saw blade teeth have worn down close to, at, or past the index. A processor may be provided that receives input from the camera and sends a signal to the indicator when the camera senses the blade teeth are worn down to the index. When the indicator receives the signal from the processor, the indicator sends a signal to the operator.

The above and other features will become apparent from the following description and accompanying drawings.

### BRIEF DESCRIPTION OF THE DRAWINGS

The detailed description of the drawings refers to the accompanying figures in which:

FIG. 1 is a perspective view of a tree harvesting vehicle with a tree harvesting head mounted to the front of the vehicle. The head includes a saw blade that is rotatably driven by the vehicle;

FIG. 2 is a zoomed in partial view of the tree harvesting head of FIG. 1 showing the saw blade having a plurality of saw blade teeth;

FIG. 3 is a perspective view of one embodiment of the saw blade teeth of FIG. 2 showing an index on the exterior surface of the saw blade tooth;

FIG. 4 is a perspective view of another embodiment of the saw blade teeth of FIG. 2 showing an index on the interior surface of a saw blade tooth;

FIG. 5 is a side view of the saw blade tooth of FIG. 3 having an index on the exterior surface of the saw blade tooth; and

FIG. 6 is a schematic of a saw blade sharpness mechanism of the present disclosure.

Like reference numerals are used to indicate like elements throughout the several figures.

### DETAILED DESCRIPTION

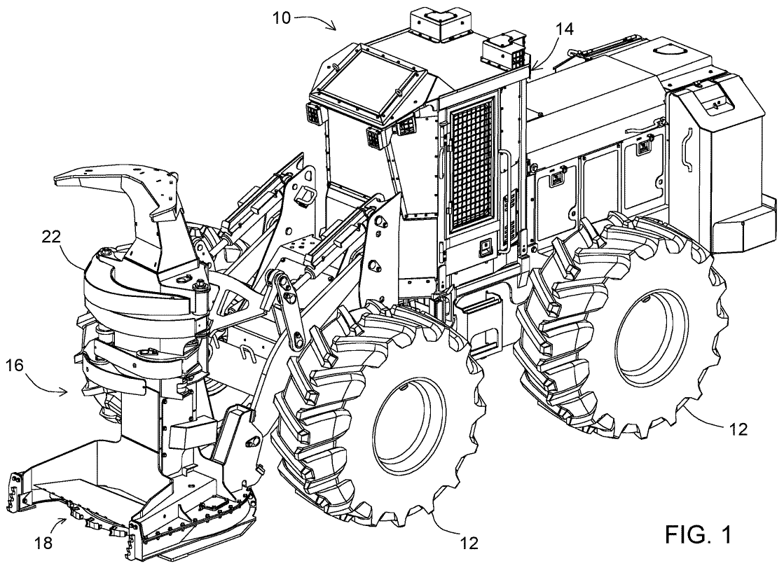

At least one example embodiment of the subject matter of this disclosure is understood by referring to FIGS. 1 through 6 of the drawings.

As used herein, unless otherwise limited or modified, lists with elements that are separated by conjunctive terms (e.g. “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g. A and B; B and C; A and C; or A, B, and C).

As used herein, the term processor refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Processor may also include components or combination of components for monitoring, recording, storing, indexing, processing, conditioning, and/or communicating operational aspects described below. Furthermore, although aspects of the present disclosure may be described generally as being stored in memory, one skilled in the art will appreciate that these aspects can be stored on or read from types of computer program products or computer readable media, such as computer chips and secondary storage devices or derived from a cloud. Processor may execute sequences of computer program instructions stored on the computer readable media to perform a method of using real-time control to determine strategies for operating a work machine, as described in detail later below\\

As seen in FIG. 1, the present disclosure can be adapted for use with a forestry vehicle 10. The vehicle 10 may have wheels 12 or tracks (not shown) to facilitate movement to and through a wooded area or forest. The vehicle 10 can include an operator station 14 or could be unmanned such that the operator is positioned remote from the vehicle 10. The vehicle 10 can include an engine for providing motive power to the vehicle 10, and for providing power to various vehicle components.

At the front of the vehicle 10 can be provided a cutting head 16. The cutting head 16 can include a saw blade 18 having saw blade teeth 20. The saw blade 18 is operatively coupled with the engine and is thereby rotatively driven. The saw blade 18 can rotate at relatively high speeds. The vehicle 10 can be driven to position the saw blade 18 into contact with a tree, and as the blade 18 rotates the saw blade teeth 20 of the saw blade 18 cut the tree. The head 16 can be provided with structure 22 to grab or hold the cut tree and may be adapted to gather and hold several cut trees. The cut tree or trees can then be transported to a pile or other location nearby.

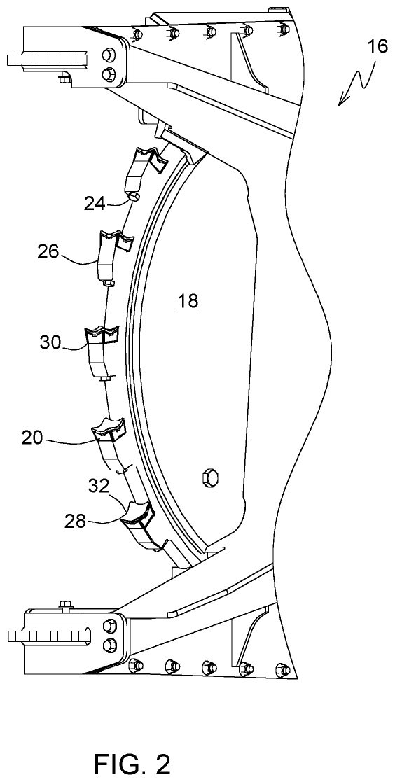

The saw blade teeth 20 of the saw blade 18 are shown in more detail in FIG. 2. A plurality of saw blade teeth 20 can be arranged around the periphery of the saw blade 18. The saw blade teeth 20 can be fixed to the disk-shaped blade 18 by way of fasteners 24 such as a screw, a bolt, a nut and bolt, or other mechanisms. The fasteners 24 extend through mounting structures 26 fixed at the outer periphery of the blade 18. The saw blade teeth 20 are fixed via the fastener 24 to the mounting structure 26, which in turn are fixed to the blade 18. The saw blade teeth 20 can be a shape other than shown in the present disclosure and can be affixed to the blade 18 by many different mechanisms. The saw blade teeth 20 could also be formed integral with the blade 18. As the saw blade 18 rotates, the saw blade teeth 20 contact the trunk of the tree to cut the tree. The saw blade teeth 20 shown in the drawings have a generally rectangular shape and have pointed corners 28 that extend outwardly from the base 30 of the saw blade teeth 20. The sharp edges 32 of the saw blade teeth 20 contact and cut the tree during tree sawing operations. When the saw blade 18 and saw blade teeth 20 are cutting a tree, the saw blade 18 will slow as it encounters resistance from the trunk of the tree. The saw blade teeth 20 will wear or dull over time, and as the saw blade teeth 20 wear and dull the saw blade 18 will slow more during cutting operations than when the saw blade teeth 20 are sharp and new.

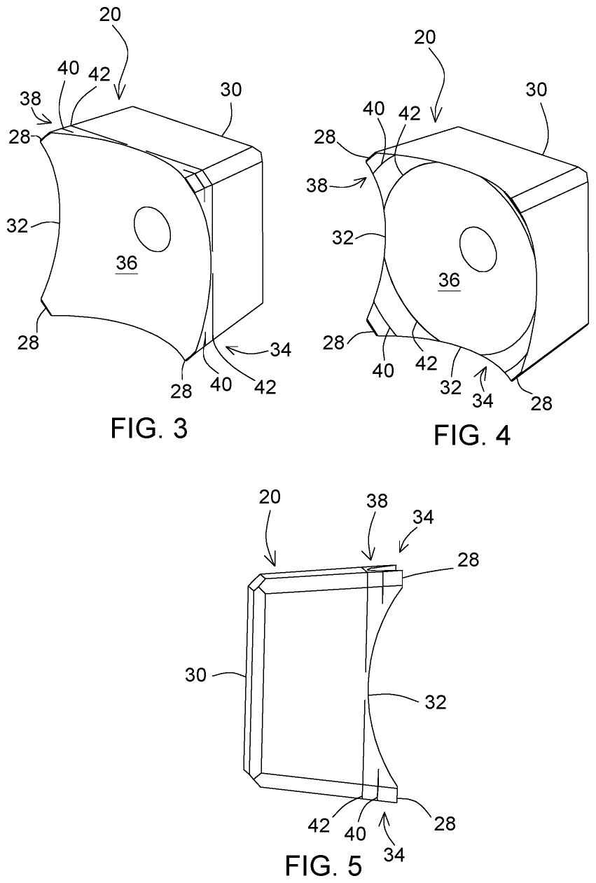

The saw blade teeth 20 according to one embodiment of the present disclosure are provided with an index 34. The index 34 can be a marking on the exterior sides of the saw blade teeth as shown in FIGS. 3 and 5. The index 34 can also be provided on the interior portion 36 of the saw blade teeth 20 as shown in FIG. 4. The index 34 can be formed into the saw blade tooth 20 during the manufacturing process, such as during the casting process. The index 34 can also be cut or otherwise formed into the saw blade tooth 20 after its initial manufacture. The index 34 is visible by an operator or a camera. As shown in FIGS. 3-5, multiple lines 38 could be formed on the saw blade tooth 20 to indicate the extent of the wear over time. As the saw blade tooth 20 becomes worn down to the line 40 closest to the sharp cutting edge 28 and 32 of the saw blade tooth 20, the saw blade tooth 20 may be partially worn. The saw blade tooth 20 wearing down to the other lines 42 of the index 34 would indicate more severe wear and more extreme dullness. The saw blade teeth 20 are shown having a rectangular shape with a curved shape formed in its end to define sharp edges 32 and pointed corners 28. Saw blade teeth 20 having other shapes could also be provided within the spirit of the present disclosure.

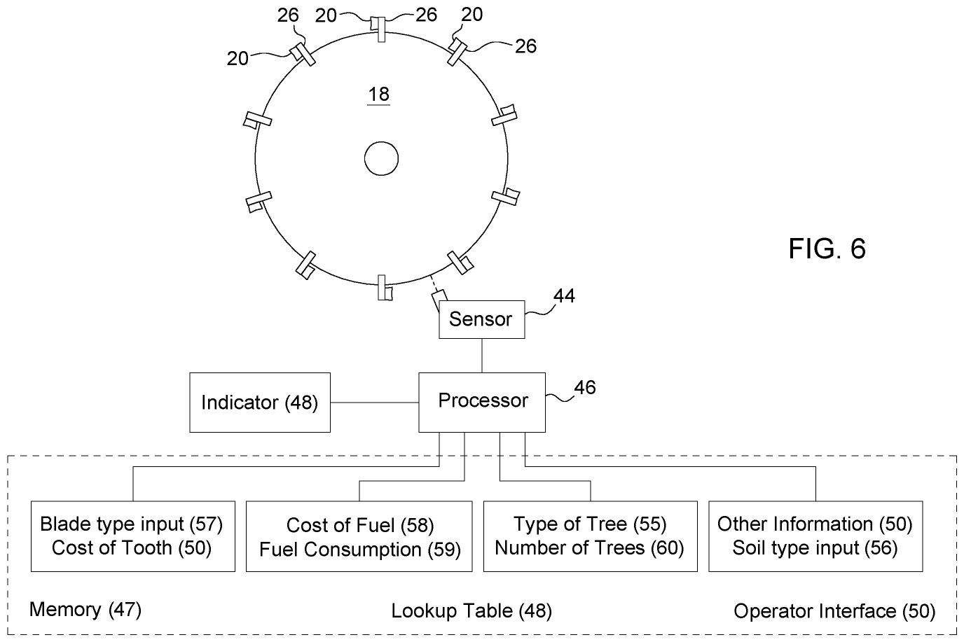

As seen in FIG. 6, the present disclosure includes a sensor 44. In one embodiment of the disclosure the sensor 44 is adapted to determine the speed of the saw blade 18. The sensor 44 may comprise a conventional mechanical or electronic RPM mechanism operatively coupled to the saw blade 18, its drive shaft, or other component, to determine the rotational speed of the saw blade 18. In another embodiment of the present disclosure, the sensor is a camera directed toward the saw blade 18 for observing the rotation of the saw blade 18 and thereby helping determine the speed of the saw blade 18. Other known mechanisms could also be used to sense the speed of the saw blade 18.

With continued reference to FIG. 6, the present disclosure includes a processor 46 operatively coupled with the sensor 44 for receiving signals or information from the sensor 44. The processor 46 can also be adapted to receive other information 50 from at least one of a memory 47, lookup table 48 stored in the memory, or operator interface 50 for receiving input from the operator such as the type of tree being cut (tree type input 55), the type of soil (soil type input 56) the trees are growing in, the cost of fuel (fuel cost input 58), the cost of the saw blade 18 and saw blade teeth 20 (blade type input 57), labor costs, etc. The processor 46 receives information from the forestry vehicle 10 including fuel consumption 59 and the number of trees cut 60. The processor 46 receives information in this manner and makes a determination of when it would be more economical for the saw blade 18 or a substantial variable in calculating the economy of saw blade tooth replacement.

Tree type input 55 may include type, size growth features, tree data, optimal cutting location on tree, for example. Soil type input 56 may include soil conditions for logging operations. As an illustrative example, machine operators managing a forest may want to know soil conditions prior to performing harvesting operations to minimize erosion from the use of harvesting equipment. In this case, if the soil is wetter than desired, erosion of the top layer of soil may be increased with the use of harvesting equipment. This erosion of the top layer of soil may impact growth of reforested trees in these illustrative examples. In other illustrative examples, drier than desired soil may cause an undesired amount of dust to be blown into the air during harvesting operations. This dust may also impact the top soil layer. In still other illustrative examples, soil conditions may aid in monitoring the risk of certain type of pests, depending on the particular implementation.

The processor 46 can receive input from the sensor 44 regarding the speed of the saw blade 18 during tree cutting operations. If the saw blade's speed drops sufficiently during tree cutting operation, this can be an indication of the saw blade teeth 20 becoming worn and dull. If the saw blade 18 slows during tree cutting operation it will take more time to cut the tree. It will also require some amount of time to get the saw blade 18 spinning again at the higher normal operating speed as the vehicle 10 maneuvers to the next tree to be cut. Power must be supplied to the saw blade 18 to increase its speed after being slowed, which requires the engine to use more fuel. Tree cutting operations are more costly after the saw blade teeth 20 become worn and dull, since it takes longer to cut trees and more fuel is consumed. When the processor 46 determines that the saw blade teeth 20 are worn to a point that it would be more economical and efficient to change the saw blade 18 or saw blade teeth 20 to provide sharper saw blade teeth 20 for tree cutting operations, the processor 46 sends a signal to an indicator 48, which in turn informs the operator to change the saw blade teeth 20. The indicator 48 can be a light in the operator station, an image on a display screen or operator interface 50, an audible alarm, or any other suitable device. If the vehicle 10 is operated remotely, the indicator 48 can be adapted to alert the operator at the remote location.

The processor 46 determines when the saw blade teeth 20 need replaced by calculating and comparing an average profit per hour of the current saw blade teeth 20 with that of new saw blade teeth 20. The average profit per hour may be calculated by subtracting the average cost per hour from the average revenue per hour.

The average cost per hour for the current saw blade teeth 20 may be determined by multiplying the amount of fuel consumed per hour by the cost per unit of fuel. The average cost per hour for the new saw blade teeth 20 includes the fuel calculation just described plus a new saw blade teeth 20 charge. The new saw blade teeth 20 charge may be stored in memory or calculated by dividing the cost of the saw blade teeth 20 by the expected life in hours.

The average revenue per hour for the current saw blade teeth 20 may be determined by multiplying the number of trees cut during the hour by the value of the tree type from the memory. The average revenue per hour for the new saw blade teeth 20 may be stored in memory.

In an alternative embodiment of the present disclosure, the sensor 44 can be a camera focused on the saw blade 18 and saw blade teeth 20. The camera can sense the speed of the saw blade 18 and relay that information to the processor 46. The camera could also be adapted for viewing the indexes 34 on the saw blade teeth 20. The image of the saw blade teeth 20 can be transmitted to the processor 46. The processor 46 may then determine from the image whether the saw blade teeth 20 have worn to or past the indexes 34. When the processor 46 detects this condition, the processor 46 can send a signal to the indicator 48, which can then inform the operator that the saw blade teeth 20 are worn and need replacing. When the worn saw blade teeth 20 are replaced with sharper saw blade teeth 20, the tree cutting operations will be faster and use less fuel, thereby cutting trees in a more economical manner.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. A saw blade sharpness mechanism for use on a tree sawing device, comprising:
a saw blade which rotates to saw trees, the saw blade comprising a plurality of saw blade teeth that dull over time during normal operating conditions, a speed of the saw blade decreases as the saw blade contacts the tree during a sawing operation, and the speed of the saw blade during sawing operations decreases more after repeated sawing operations as the saw blade teeth become dull;
an indicator that sends a signal to an operator;
a sensor that senses the speed of the saw blade, and senses the decreasing speed of the saw blade during sawing operations; and
a processor that receives an input from the sensor, the processor determines when the speed of the saw blade during the sawing operation has decreased due to wear to a point that it would be more economical to replace the saw blade teeth with new sharper saw blade teeth, and the processor sends a signal to the indicator to send the signal to the operator when such condition occurs.

2. The mechanism of claim 1, wherein the processor receives a blade cost input from one or more of a memory, a lookup table, and the operator interface.

3. The mechanism of claim 1, wherein the processor receives a fuel cost input from one or more of a memory, a lookup table, and the operator interface.

4. The mechanism of claim 1, wherein the processor receives a tree type input from one or more of a memory, a lookup table, and the operator interface.

5. The mechanism of claim 1, wherein the processor receives a soil type input from one or more of a memory, a lookup table, and the operator interface regarding the type of soil in which the tree is situated.

6. The mechanism of claim 1, wherein the sensor is a camera directed onto the saw blade, the camera sends data to the processor, and the processor calculates the speed of the saw blade during operation based on the data received from the camera.

7. The mechanism of claim 6, wherein the camera also sends images of the saw blade to the processor when the blade is still, and said processor determines whether the saw blade teeth are worn to the point of being ready to be replaced.

8. The mechanism of claim 1, wherein the sensor comprises a camera, and an index is formed in at least one of the saw blade teeth, the camera sends images of the saw blade teeth and index to the processor, and said processor determines from said images when the saw blade teeth are worn to the index.

9. The mechanism of claim 1, wherein the sensor is mechanically coupled to the saw blade to sense the speed of the saw blade.

10. A saw blade sharpness mechanism for use with a tree harvesting head, the head having a saw blade with saw blade teeth that rotates to saw trees, the saw blade teeth dull over time during normal operating conditions as the saw blade cuts trees, and the dulled saw blade will slow more while cutting a tree than a sharper newer blade will, the saw blade sharpness mechanism comprising:
an indicator that sends a signal to the operator,
a sensor operatively coupled to the saw blade for sensing the speed of the saw blade, and
a processor operatively coupled to the sensor to receive input from the sensor, and the processor is operatively coupled to the indicator, the processor receives input about the cost of the blade from one or more of a memory, a lookup table, and the operator interface, and the processor receives input regarding the speed of the saw blade from one or more of a memory, a lookup table, and the operator interface and utilizes the speed input and the cost of the blade to determine when the saw blade teeth have dulled to the point that it would be more cost effective to continue sawing operations with new saw blade teeth, at which point the processor causes the indicator to send a signal to the operator.

11. The mechanism of claim 10, wherein the processor receives inputs from one or more of a memory, a lookup table, and the operator interface regarding the cost of fuel to run the tree harvesting head.

12. The mechanism of claim 10, wherein the processor receives inputs from one or more of a memory, a lookup table, and the operator interface regarding the type of tree being sawed from the memory.

13. The mechanism of claim 10, wherein the processor receives inputs from one or more of a memory, a lookup table, and the operator interface regarding the type of soil in which the tree is situated.

14. The mechanism of claim 10, wherein the processor receives inputs regarding the cost of fuel to run the tree harvesting head, the type of tree being sawed, and the type of soil in which the tree is situated.

15. A mechanism for use on a tree sawing device, comprising:
a saw blade which rotates to saw trees, the saw blade having at least one saw blade tooth, and the saw blade tooth having an index, the saw blade tooth wears over time during normal operating conditions,
an indicator that sends a signal to an operator,
a camera directed onto the saw blade tooth,
a processor that receives inputs from the camera, the processor sends a signal to the indicator when the camera detects when the saw blade tooth is worn to the index, and the indicator then sends a signal to the operator.

16. The mechanism of claim 15, wherein the index is formed on the side of the saw blade tooth.

17. The mechanism of claim 15, wherein the index is formed on an inner portion of the saw blade tooth.
